(19) United States
(12) Patent Application Publication
(10) Pub. No.: US 2008/0195469 A1
(43) Pub. Date: Aug. 14, 2008

(54) Auctioning to Obtain Customers

(76) Inventor: Steve Toneguzzo, New South Wales (AU)

Correspondence Address: MICHAEL MOLINS;MOLINS & CO., SUITE 5, LEVEL 6, 139 MACQUARIE ST, SYDNEY NSW, 2000, omitted

(21) Appl. No.: 11/630,644

(22) PCT Filed: Jun. 30, 2005
(86) PCT No.: PCT/AU2005/000949

§ 371 Date: Dec. 26, 2006

(30) Foreign Application Priority Data
Jun. 30, 2004 (AU) 2004903551
Jun. 30, 2004 (AU) 2004903552
Jun. 30, 2004 (AU) 2004903553
Jun. 30, 2004 (AU) 2004903554
Aug. 25, 2004 (AU) 2004904827
Sep. 27, 2004 (AU) 2004905543

(51) Int. Cl. G06Q 30/00

(52) U.S. Cl. 705/14; 705/37

(57) ABSTRACT

Businesses compete for a patron's business in an auction. A patron or customer provides preferences about an anticipated visit. Businesses are provided, by an agency, with information about the customer and their preferences. Bids entice the customer based on the preferences. The customer selects a business to patronize based on the bids. The agency receives a fee from the businesses.

### FIELD OF THE INVENTION

One embodiment of the invention pertains to networked games and apparatus in which an actual currency or virtual currency (including points) or game based currency is used to: (a) participate or wager on an outcome of a contest of skill or chance or stamina or any combination thereof, (b) insure against an outcome, or (c) enhance the players chance of success in the contest.

Another embodiment pertains to methods for the presentation of games of chance or skill at a different time and location to that of actual result determination using a technological aid.

Another aspect of the invention pertains to methods for the conversion of customer loyalty points into a different medium of exchange.

### BACKGROUND ART

Networked games are well known. Game-based currencies are also known to exist. Game-based currency (“GBC”) is currently known to be used to purchase items such as virtual real estate or virtual weapons or armour.

Electronic gym, racing simulations and other like sporting equipment and simulation equipment is known to exist. A person uses equipment of this kind, generally to simulate an activity, and can produce one or more output signals that are indicative of a user's performance.

Networked, simulated casino style games, Internet poker and even Internet billiards exists currently. These games may be played for points or tokens or simulated or real cash.

Internet Sports betting exists, whereby the participant may wager on the outcome of a real event, or in the case of fantasy sports, a simulated event.

The purchase, game determination and payment of prizes will generally occur in a licensed area or another location where it is legal to gamble and in accordance with appropriate legislation which usually specifies that location and time. The actual gambling location may be unlimited where the activity occurs using a PC or wireless or other computing device.

Technology assisted gambling comes in many forms such as poker machines, lotteries, internet, wireless or other forms of remote gaming. Many forms of chance and skill games are available.

In the United States and other jurisdictions “remote” or off-site gambling is considered to be illegal. Certain exceptions are:
a) In the generation of a scratch lottery or pull-tab the tickets are pre-printed at a location other than the location where they are purchased and “played”.
b) The purchase of a scratch lottery ticket at an agency (the game is pre-determined at the time of purchase) then scratching to reveal the prize at the venue where it was purchased, or at a later time and place. The winner must generally return to a licensed area to claim the prize. In this case no electronic aid is used to display the results.
c) In online lotteries a pool of “pull-tab” results may be pre-generated electronically and at the time the player places a wager to purchase a ticket, the result is displayed. This is not legal in all jurisdictions.
d) In Class II Indian Gaming where a “technological aid” to Bingo and Pull-Tabs is permitted, an electronic “pull tab” machine may be loaded with a CD containing previously determined game outcomes. A person who plays the machine simply sees a display of the pre-determined pull-tab outcomes (often in the form of a slot machine display) as the individual pull-tabs are also printed. They must then take the winning printed tickets to a cashier to redeem their prize.
e) Parimutuel, interstate horse wagering.

A third embodiment relates to loyalty points. Shells or cattle were used in antiquity as a form of currency. Today, the second largest currency in the world is loyalty points. These points may form a significant liability on the balance sheet of a company, particularly if it were required to disclose them as a liability in an annual report. It would be convenient for large corporations to seek alternate means to dispose of their loyalty points liability. One effective way to do so is to have them used in gambling transactions.

As with most businesses, the primary means of growth for properties in Las Vegas involves the acquisition of new customers. This could involve finding customers who previously were not aware of product (first time to Las Vegas), were not candidates for purchasing product (just turned 21 years of age), or customers who in the past have bought from competitors. Some of these customers might have been customers previously, which could be an advantage (more data might be available about them) or a disadvantage (they might have switched as a result of poor service).

The traditional approach to customer acquisition involved a marketing manager developing a combination of mass marketing (magazine advertisements, billboards, etc.) and direct marketing (telemarketing, mail, etc.) campaigns based on their knowledge of the particular customer base that was being targeted.

Las Vegas type casino gaming customers tend to cross all marketing platforms:
(a) Promotional offer seekers
(b) Customers loyal to one property
(c) Affluent visitors with no disposable income conscience

The one attribute that crosses all these sectors is that Las Vegas visitors like to feel special and like to feel that the operator is taking care of them.

With new reporting laws, such as Sarbanes-Oxley, the US Securities and Exchange Commission and federal authorities are moving in a direction where these point liabilities will have to be reported on companies' balance sheets and expensed on their income statements, driving down profits and stock prices. Companies will be in a hurry to unload the liabilities, which amount to billions of dollars. Customers receive value for their asset, gaming operators gain tax-free revenue and Clearing House receives a broker fee.

Successful loyalty marketing programs create loyalty to the brand. Performance is judged with a combination of behavioural and attitudinal measures, and the objective is to focus and deepen the existing customer relationship, by offering relevant rewards that reinforce the brand values.

Loyalty marketing is a strategy, not a tactic. Customer loyalty, and customer loyalty acquisition, is based on relationships. In loyalty marketing, the program designed to motivate and encourage desirable behaviours by using the right rewards and personalization, ensures loyalty almost every time, and for the long term.

Currently, Las Vegas operators use loyalty point rewards programs, mainly through the tracking of a customer's play via player cards or observation of staff. An aspect of this invention provides the necessary tools to help gaming operators maximize their acquisition and loyalty programs, all at once.

### SUMMARY OF THE INVENTION

In a first embodiment a networked adventure or simulation game or contest or similar, players, participants or third-part observers may use an actual or virtual or game based currency (“GBC”) for gaming and wagering transactions, including the purchase of insurance or to increase their chances of success within the game.

The game or contest may be witnessed, for example in a network environment, by any party via visual signals such as a screen or virtual reality display or hologram or via a voice or other auditory or sensory signal. For example, users, spectators or gamblers may appear as avatars or themselves in a simulated stadium or grandstand, whilst performers may appear as avatars or themselves on a simulated racetrack, golf course, basketball stadium or other such sporting facility.

In a second embodiment, gambling games of chance or skill (however and whenever determined) may be re-played or displayed to simulate a result at a location and time other than the exact location and time where and when the game transaction was made.

A third embodiment has three separate aspects:
(a) “Auction House”—businesses compete for a patron's business.
(b) “Clearing House”—businesses can dispose of point liability via a point exchange.
(c) “Lottery”—businesses can dispose of point liability via a lottery or similar.
   Clearing House and Auction House could be melded into one business model, method and architecture, based on a promotional currency.

### BRIEF DESCRIPTION OF THE DRAWING FIGURES

FIG. 1 is a flow chart illustrating a game transaction interface;

FIG. 2 is a flow chart illustrating a process flow for the remote witnessing of a game;

FIG. 3 is a flow chart illustrating methods for auctioning customer expenditures;

FIG. 4 is a schematic diagram of business architecture;

FIG. 5 is a flow chart illustrating the steps associated with a loyalty marketing business; and

FIG. 6 is a flow chart illustrating the steps in a lottery method involving promotional currency.

### BEST MODES AND OTHER EMBODIMENTS OF THE INVENTIONS

In one embodiment, a simulated “International Sporting and Athletic Games” could be facilitated using real competitors competing with each other in real-or near real-time events, being watched and wagered on by millions around the world, without anyone needing to leave their hometown.

Monitoring of the event may be done by email, telephone, SMS, kiosk, narrowcast, broadcast etc. Users include performers, wagerers, and spectators. Users of the system may wager on an outcome determined by the performers. In some embodiments only selected users can make bets. Performers may be excluded, as may certain users based on age, location or conflict of interest

Performance equipment and other components may be subject to scrutiny and testing to provide for integrity in the game or contest.

Performers, players or spectators (players) may pay a fee to enter such that the sponsor, house (provider of the equipment) or server operator obtains a percentage and the winner of the event obtains a prize pool.

In the alternate, the event may be web-cast or broadcast and a sports-book managed by an entity to enable parties independent of the participants to wager on the outcome.

In one example the player or players uses the game based currency to wager in a virtual casino or sports book associated with the game. A virtual sports book may take bets on actual sub-games (for example, fights or battles) within a game.

A player (or team of players) uses a game based currency to enter a virtual tournament whereby the house, sponsor or server operator takes a percentage of the entry fee and the winner takes the balance (e.g. a virtual jousting or fighting competition).

A player or players use the game based currency to insure themselves through a virtual “broker” against loss in a game (loss of property, virtual life or virtual health etc.).

The Invention also contemplates the provision of insurance within a game.

A player or players use the GBC to enhance their chances of success in the game (extra strength, weapons, engine parts, etc.). A player or players use the game based currency to purchase virtual components that have specific characteristics that when combined result in the creation of a virtual vehicle or combat weapon or other device to be used in the game, a sub-game or tournament. The game based currency is to be used for the payment to assemble the components and the reliability of that assembly may be based on a random outcome or component of skill (e.g. based on the experience of the assembler). That reliability factor can then be a consideration in the determination of a “breakdown” or “malfunction” in a game, sub-game or tournament.

Important components of this invention include:
a) A contest: of chance, skill, stamina or one of more of these attributes.
b) A game based currency: Representations or symbols of real money, simulated money, an invented currency, or loyalty or other points that are convertible by the player into real money.
c) Players in the game: Contestants or spectators.
d) Virtual representations of the participant on a display visible to either participants or spectators.
e) A simulation device or apparatus: To enable participants to engage in the game or contest.
f) A networked output device: To enable participants to see, hear, feel, sense, smell or taste the event and the outcome.
g) A game transaction engine interface: To enable the participants or spectators to insure themselves or others, wager on an outcome involving themselves or others, enhance their chance of success or enter a simulated casino or betting shop—a game within a game.

It is envisaged that (g) may be added to existing simulated sporting games such as golf or multi-user adventure games. It will be understood that the operator of the game may profit either by collecting fees or talking a fee or a percentage of the transactions generated by converting real to GBC, or GBC to real money. Fees may be collected based on player participation or through commissions on the sale of insurance, premium weapons, game tools etc.

In the example of simulated golf, extra money could be paid to obtain better clubs (enhancement).

In the example of an adventure game the player could;
(a) Insure themselves against getting “killed” by a monster or other player,
(b) Place a wager on the outcome of a fight they (or their team) are about to participate in with another player(s).
(c) Place a wager on a fight about to occur in the game, that the player will observe.
(d) Enter into a tournament whereby an entry fee is paid and the winner and the house divide the pool of entry fees.
(e) Engage in transactions with a virtual gambling house within a game.

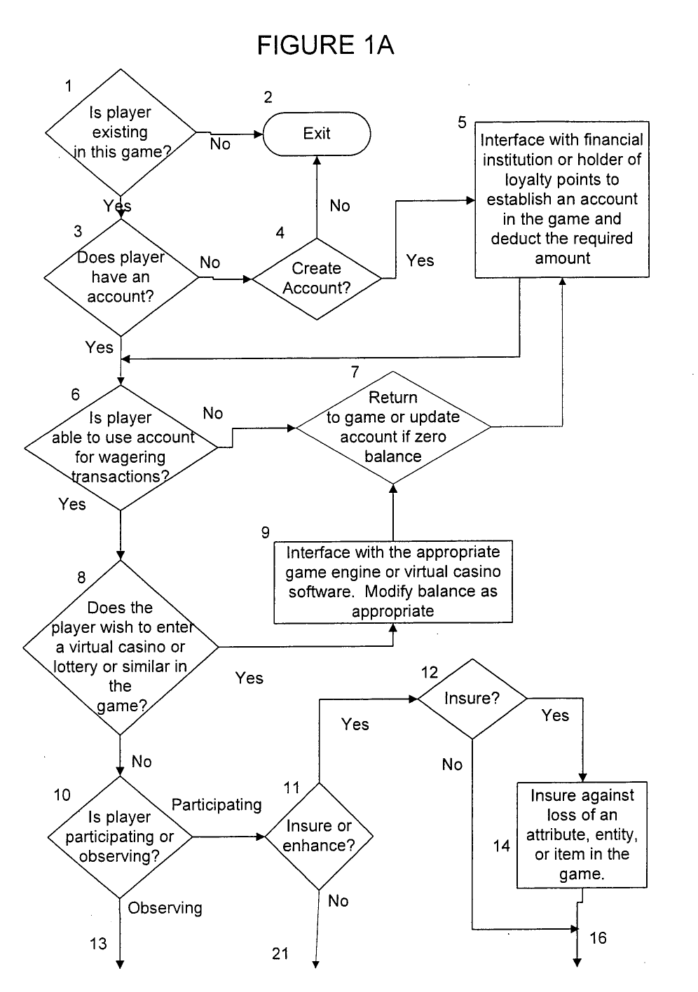

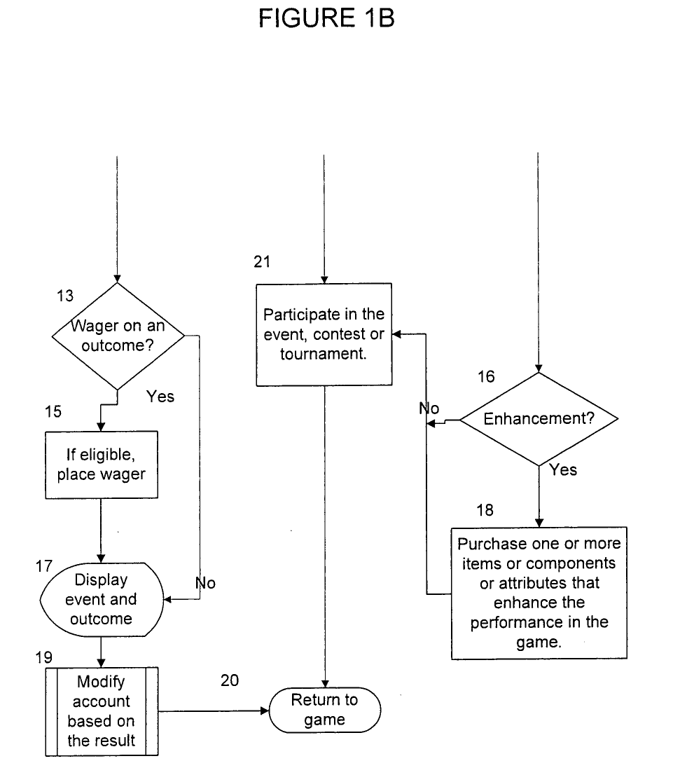

The game transaction engine interface, process flow is represented in FIG. 1.

In a second embodiment, player purchases one or more games at a particular location. The location may be a casino. Where the gambling activity occurs using a PC or wireless communications device, the actual gambling location may be anywhere. These games may be games of chance or skill. The result for these games may be determined, e.g. in bulk, at the time or purchase (e.g. slot type game) or may be pre-determined (e.g. scratch type lottery ticket). The game results may or may not be played or witnessed at the time of purchase.

In this embodiment, the game result is stored on a device (other than a printed ticket) and is able to be recovered and displayed either using the storage device or another means to access the storage device.

Using a technological aid, the game play may be witnessed by the player remotely from the exact or actual location of gambling at a different time from where and when it was purchased or first carried out.

By way of example:
a) A player enters a licensed area (e.g. a casino) and is identified (e.g. using a player loyalty card). The player then plays 100 games at a slot machine and the results of those games are stored, for example, to a database. The player collects their winnings as usual. The player then goes home, logs onto a player loyalty or other Internet account using some form of identification and requests to re-play the games purchased and determined earlier, over the Internet, pay TV, mobile phone or other communication media.
b) A player enters a licensed area (e.g. a casino). The player then purchases 100 games of a favourite game at a terminal and the results of those games are stored. The player is either provided with a transaction identifier or is identified (e.g. using a player loyalty card) and the game results are linked to either the player ID or the unique transaction ID. The player chooses not to observe the game outcomes or to collect their winnings at that time. The player then goes home, logs onto the venue's web site account using some form of identification and requests to re-play the games played that day over the internet, pay TV, mobile phone or other communication media. The player thus watches the games play from a remote location and at a remote time. The player observes their winnings and losses and at a later time. The player then enters a licensed area and provides their transaction ID or player loyalty ID to redeem any winnings that are owed. The player may also choose to redeem the winnings at the time of purchase.
c) A player may elect to hear the results rather than see them (e.g. a simulated race called over the telephone or internet).
d) Rather than an electronic identifier (e.g. transaction ID or player ID), the player may elect to have the results loaded on a mobile device (such as a smart card, mobile phone, PDA, or other device.
e) Rather than an electronic identifier (e.g. transaction ID or player ID), the player may elect to purchase a device with the results pre-loaded. The player may elect to re-use that device time and time again.
f) A player gambles using any form of gaming device also including a networked communications device such as a PC, telephone, mobile phone, PDA or kiosk. A result is obtained from the operator's networked server. The location where and technical means by which the gambling occurs is thus without limitation. At a later time, or at a different place, or both of these, the player re-plays the games, thus witnessing the original game play remotely. The re-play may use the same or a different communications device. The purpose of the re-play is primarily for the player to witness the gaming outcome for the first time.
g) The technology involved may be an adaptation of existing Internet gaming systems, systems based gaming, or lottery systems or similar.
h) Actual currency, a representation of actual currency, points or “promotional play” may be used to place a wager and pay a prize.
i) It is commonly known to game developers that games are generally comprised of (a) sound, (b) graphics, (c) game engine (i.e. how the game is played), and (d) pay table (i.e. how the game prizes are awarded). Provided (c) and (d) are constant, various graphics and sounds can be substituted to “re-skin” the game. So essentially, a player could be presented with many different graphic or sensory representations of the same game. Hence, this invention provides for the option of a player to select from a variety of game “skins” to remotely witness the outcome of prior game play.
j) Single-state games (e.g. a spinning reel slot machine simulation), involve no player participation: You either win something or you do not. Multi-state games (e.g. draw poker) generally involve an aspect of player choice. The invention provides for the player to “replay” a multi-state game but be awarded the prize for the best hand they could obtain. This is illustrated by way of the following example:
   a) The player has previously purchased a $1 hand to replay.
   b) The computer selects 10 random numbers and maps them to a deck. Lets say: A-C A-H K-C 2-D 5-D 3-S Q-D A-D 4-D 8-H (where C=clubs, D=diamond, H=hearts, S=spades)
   c) The first five cards are dealt: A-C A-H K-C 2-D 5-D
   d) The player discards the last two cards and is provided with replacements: 3-S Q-D
   e) The player now has a final hand of: A-C A-H K-C 3-S Q-D
   f) The player is paid for an inferior hand, being a Pair of Aces: Say $25. The player is also paid a $25 Bonus in some manner because the best the player could have done was to discard the last three cards: K-C 2-D 5-D
   g) Hence a superior hand in this situation would have been: A-C A-H 3-S Q-D A-D, or Three Aces.
   h) Lets say Three Aces pays $50. Hence, the difference is $25. As this is a pre-played game the net return to the player in the replay cannot deviate from the original game play. Hence the optimum outcome must be applied in all cases. Had the player originally discarded the three last cards and realized three aces, no bonus would have been paid.
   i) An alternate to actually playing the hand once, is to keep replaying it until the optimum strategy (e.g. the choices that pay the highest prize) are obtained.

To further illustrate how player choice has no impact on the prize outcome, the following example is provided:

The first hand is A A A A 7, say.

One could make an irrational choice and discard A A A 7, leaving the player with only an A. If it so happens that the next four cards in sequence are K, Q, J, 10 of the same suite as the A, then the player will have obtained a high award from an irrational choice.

However, in “remote witness of game play” because the game is pre-purchased (and top prize pre-determined), the player's choices do little more than provide an interaction, regardless of what they do, they will win the same amount. Hence;
The irrational play would see the player win the prize for a straight flush.
The rational play would see the player win the prize for four aces+a bonus=the same prize as the straight flush.

The deck is essentially reshuffled at every hand, so one has no way of knowing the state of the deck. At the start of each play there are 10 cards pre-selected, those cards and the sequence of those cards cannot change.
j) An alternate method to provide multi-state games is demonstrated as follows:

A perfectly random 5 cards are dealt. The server will then use “optimum strategy” to determine what cards to hold. Then, the server will deal the requested cards to the “discarded” slots. The resulting hand is analysed, and a payback for that hand is assigned.

Now, when the player goes to make his choice of outcome, the same random cards are analyzed in place of the player's discards. Then the following analysis takes place:
a) If these cards do not yield a result equal to or less than the pre-determined payback, then another set of random cards is drawn. This is continued until the result is equal to or less than the pre-determined payback.
b) If the cards yield a result equal exactly to the predetermined payback, then the player is shown those cards, and the payback is awarded. The player is given no “bonus money”.
c) If the cards yield a result less than the predetermined payback, then the cards are shown to the player, and a “win” equivalent to that player's resultant hand is displayed. Further, a “bonus” is awarded in the amount of the pre-determined payback minus the displayed payback.

Important components of this embodiment are that there must be:
(a) A networked based gaming system complete with game engines, transaction processors and an account keeping capability. Such a system would be an Internet casino, for example.
(b) A remote interface to the gaming system such as a web site, remote or wireless terminals.
(c) A “remote witness of game play interface” or API.

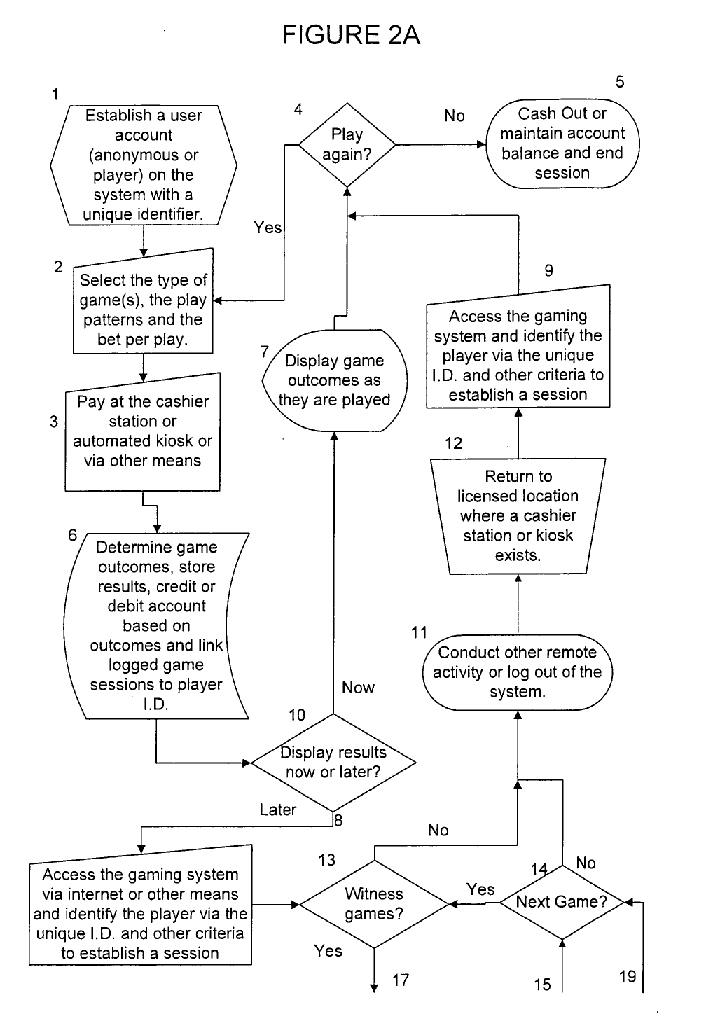

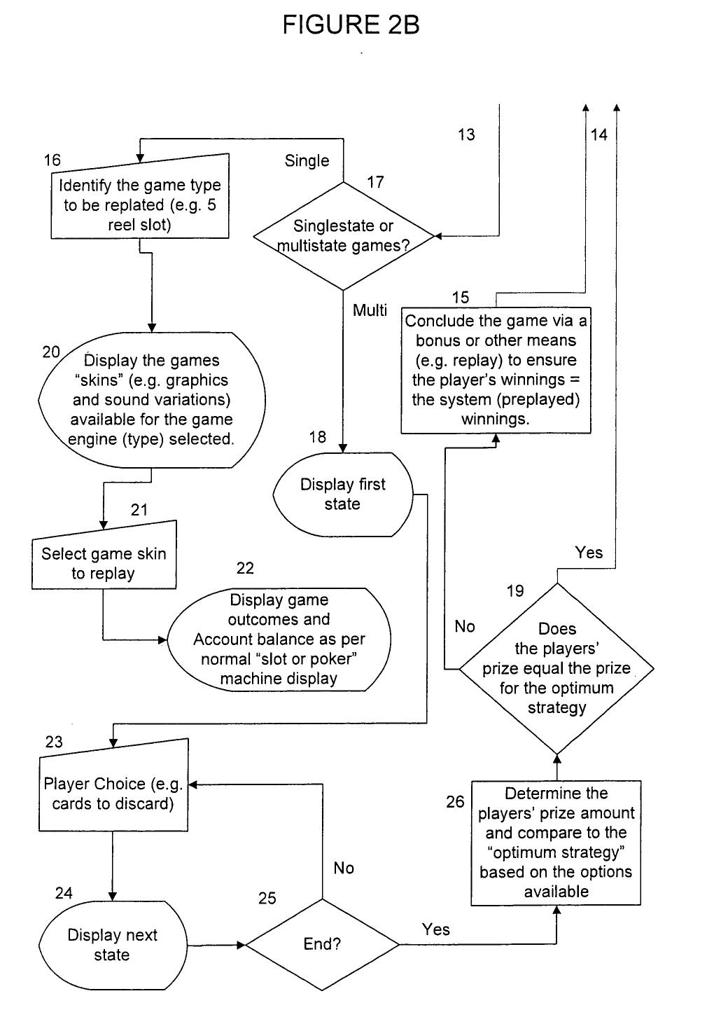

The process flow for the above embodiment is illustrated in FIG. 2.

A third embodiment brings gaming operators and customers together, with each party achieving exactly what they want. The customer wants value for his business—this could be in the form of discounted rooms, free entertainment, complimentary dining or promotional play at the casino, i.e. “comps”. These are standard offerings in Las Vegas. However, sometimes the customer may only realize these benefits after his stay, if at all. There are times when customers have reached a property's comp level, never to receive any complimentary offers prior to the end of their visit.

This embodiment allows customers to receive their comps before they visit and provides the customer with the ability to put their business “out to bid”.
1. The customer provides the operators with their preferences about a planned visit, for example, planned visitation date, the amount of spending money they are bringing with them, and their favorite activities.
2. The information is displayed to the operators who will then decide what types of complimentary items or discounts they will make available to that customer for that spending level.

The customer selects the offer that provides him the best value, or suits him the best.

Important components of this invention are:
(a) An existing promotional, loyalty marketing system in place with the Operator,
(b) An interface with the operator to exchange information and facilitate transactions,
(c) A computerized system to facilitate; (a) the acquiring of client expenditure limit and requirements, (b) the auctioning of the client's planned expenditure, and the transaction processing, and
(d) A provider of the cash for promotion exchange service that operates and manages the computerized system.

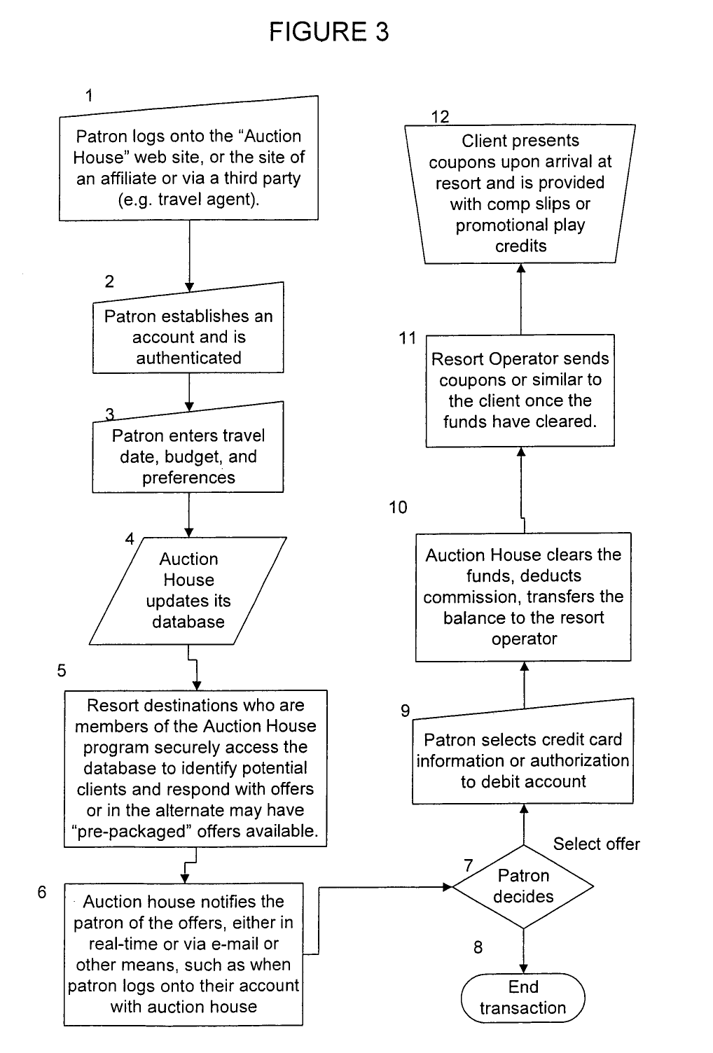

The process flow for the third embodiment is represented in FIG. 3:

### Example

John Smith logs on to the operator's website (referred to as “Auction House” herein and in the drawings) and enters his information e.g.:
He will be visiting Las Vegas with his wife for three nights June 2 to June 5,
They will be spending $2,000 in spending money
They likes to play craps, go to shows and eat at fine restaurants
Auction House charges his account $2,000 (from which it deducts a fee before handing the difference over to the operator).

The Auction House displays this information to the operators, and they bid for John's business:
ABC Grand will offer John and his wife 25% off normal room rates, 2 free meals and give him two free tickets to see a show for Saturday June 4^{th}.
Casino Palace offers John and his wife two tickets to see a show Friday June 3^{rd} and gives them $3,000 in promotional casino play.
Vegas Bay offers John and his wife $2,000 in promotional casino play.
Game Island is almost sold out that weekend, so they only offer a 10% reduced room rate.

John and his wife choose to stay at Casino Palace and they are directed to bring their confirmation package to the VIP Desk upon arrival.

### The Benefits to Each Party are:

John and his wife
   Feel special that the properties were vying for their business
   Receive $3,250 in value (their $2,000, $1,000 promotional play, and $250 in value for the tickets)
Casino Palace
   Gain The Smith's business (customer acquisition)
   Add them to their database for marketing (loyalty marketing base) Fill their casino with loyal customers
   The promotional play is tax exempt (in Nevada), therefore instead of being taxed 6.5% on $2,000, they are taxed nothing on $3,000.
Auction House
   Receives a fee (say, 5%) as the broker for the transaction ($100)

It's a “win-win” for everybody. The properties have the ability to offer more discounts and comps at slower times, and continually update offerings based on market demand. Customers receive complimentary offers up front, creating loyalty and value, and the two may continue a relationship in the future. It's a simple customer acquisition and loyalty marketing tool all in one. Large travel agencies could be used as affiliate marketers/front-end partners to increase the potential market.

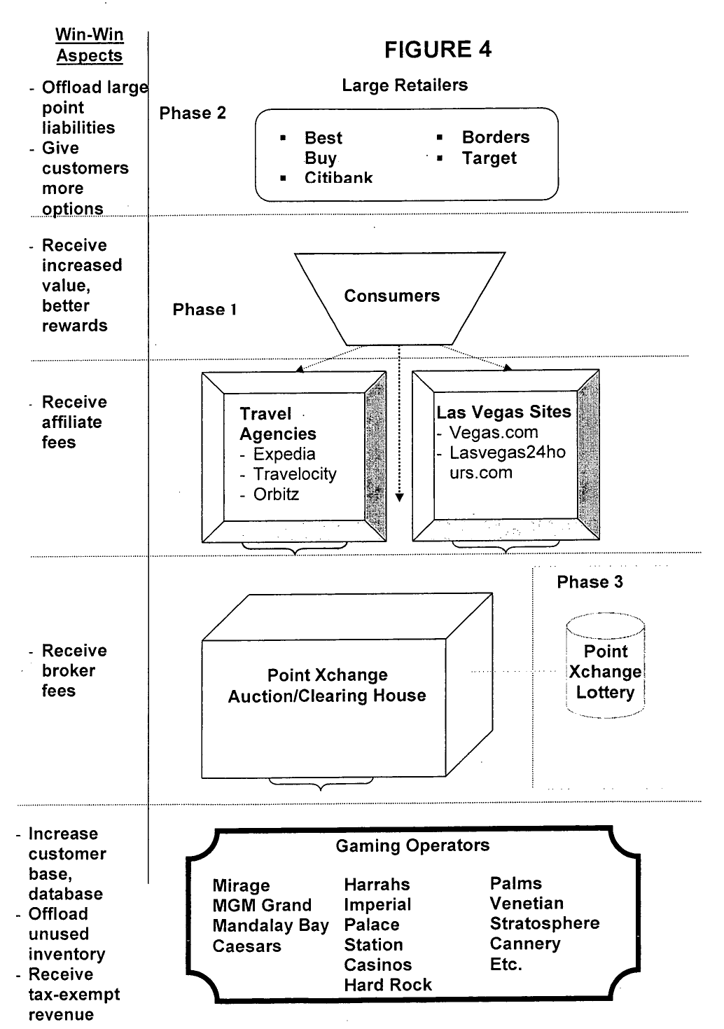

A schematic diagram of a business architecture relating to an auction for a customer's business as shown in FIG. 4.

### Example

### Financial Model

Summary financial model follows:

| Auction House Estimated Year 1 Revenue | |
|---|---|
| 2004 Las Vegas Visitor Volume | 37,400,000 |
| 2004 Online Booking Percentage | 23% |
| Estimated Visitors Booked Online | 8,533,000 |
| Clearing House Est. Market Share | 1% |
| Clearing House Est. Customer Base | 85,330 |
| 2004 Avg. Expenditure per Las Vegas Visitor | $901.34 |
| Est. Clearing House Market | $77,570,000 |
| Clearing House Fee Percentage | 5% |
| Clearing House Est. Revenue Year 1 | $3,878,000 |
| Gaming Operators Estimated Year 1 Revenue | |
| Clearing House Customer Base | 85,330 |
| 2004 Avg. Gaming Expenditure per Las Vegas Visitor | $545.00 |
| Incremental Revenue to Operators | $46,500,000 |
| Plus: Tax Saving due to Promotional Play (6.5%) | $3,022,000 |
| Less: Clearing House Fee | $3,878,000 |
| Total Net Incremental Gaming Revenue | $45,644,000 |
| Gaming Operators Build Loyalty Marketing Database | |
| Assume that 50% of patrons are not in the database: | 42,665 |

Loyalty marketing rewards campaigns in every industry—travel, retail, books, banking
give their customers reward points for doing business with companies. However, many times the rewards offered (watches, flights, etc.) are not suitable for the customer or are not considered valued products.

A further embodiment referred to as “Clearing House” takes on point liabilities from different organizations and converts them to a universal or pseudo “currency” that may be adopted by various organizations to trade in goods and services, or for gaming. “Clearing House” refers to a brokerage or agency that may operate a web based system to facilitate the transactions disclosed herein.

### The Benefits to Each Party are:

Customer
   Greater flexibility with the use of points.
Retail Company
   Eliminates the point liability from its books
Clearing House
   Receive a fee (%) as the broker for the transaction

The major components of this invention are that there must be:
(a) An existing promotional, loyalty marketing system in place with the suppliers of goods and services,
(b) A computerized system to facilitate the transfer and funds management of point equivalent currency, and
(c) A provider of the point exchange service that operates and manages the computerized system.

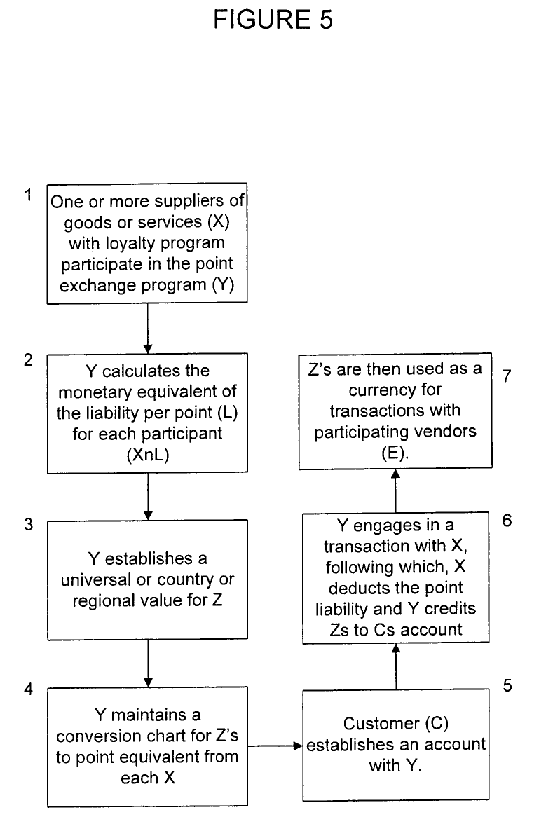

The process flow for the above methods is represented in FIG. 5.

This next embodiment pertains to the creation of a lottery using the created promotional currency or by way of contribution of different point programs toward the acquisition of an entry “ticket”.

As customers convert their points through “Clearing House”, they can use their points to buy into lottery drawings and sweepstakes or similar or in the alternate, the Clearing House will act as the “broker” of points and operator of the lottery.

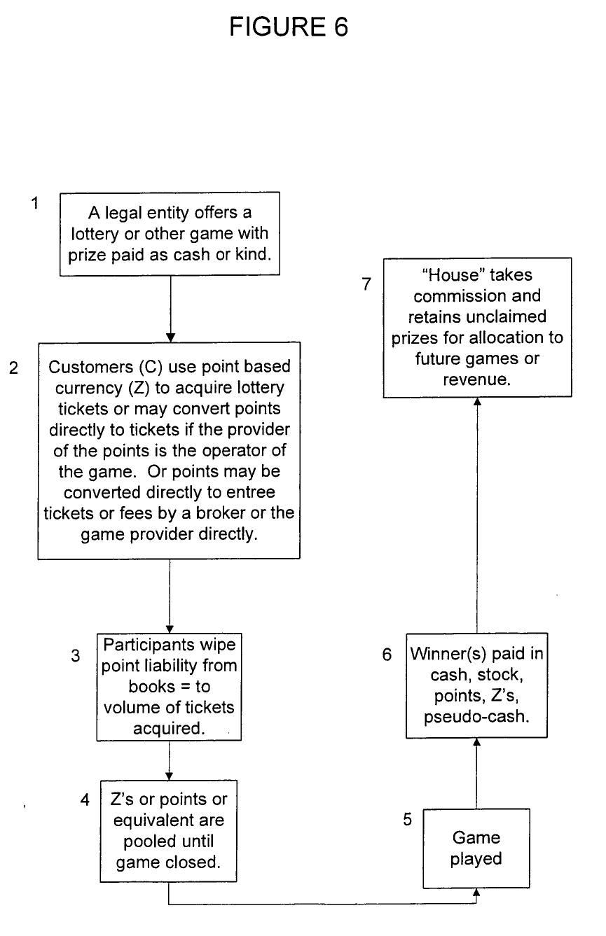

With reference to FIG. 6, for example, “X” is a company that provides a product or service and a loyalty point program.

“X” has determined that one loyalty point has a specific liability, “L”. A customer, “C”, of X has accrued “M” loyalty points with X.

X has an affiliation with a Points Clearing House (or brokerage or auction provider), “Y”.

Y also has relationships with one or more entertainment, retail facilities, or any other merchant or provider of goods or services, “E”, who desire to secure C's points in the form of an actual or invented means of exchange or currency “Z” (possibly referred to promotional credits or “dollars”) and thereby attract C to utilize facilities or services of E.

In the alternate, X may also perform the role of Y or E may perform the role of Y. In the example of a shop, the offer may be that if C purchases a thing, C can purchase any other thing to the value of the total of accumulated Zs.

In the case of the casino industry, Zs may be “Promotional Dollars” which are a generally accepted term whereby a player must play the promotional dollars, the player cannot cash them, but they are permitted to convert any winnings to cash or kind. Promotional dollars are an attractive way to secure the patronage of C when they visit, often resulting in purchases at other facilities in the casino, accommodation, or additional gaming spend.

In one embodiment C calls an employee of Y to engage in dialogue, or accesses Y's computer servers over the Internet, pay TV, mobile phone or other communication media. C identifies how many Zs Y's E affiliates are offering in exchange for C's points held with X. Or in another embodiment, how many Zs will E allow C to convert their N points held with X to?

C is planning a trip to Las Vegas and notes that E1 casino is offering an attractive deal that, for example, if more than 50,000 Zs are converted, E1 will provide a free room. C likes that deal, and instructs Y how many points they wish to convert to Zs with E1 and proceeds with a transaction.

“Y” negotiates to take a number, “N” (where N<=M>o) of C's points off X at a value “V” per point where V would generally be less than or equal to L.

In one example, X transfers the points to Y at no cost, V=o in order to reduce X's liability.

Or X may pay Y, V/point to take the N point liability. Hence X's liability is reduced by N×(L−V).

Or Y may pay X, V/point to take the N point liability. Hence X's liability is reduced by N×(L+V).

Y now holds N points for, or in trust for C.

In one example, Y sells C's points to the chosen E at a pre-agreed rate.

Or Y advertises C's points for sale to its E affiliates at a given rate, and whomever sees the deal being most attractive buys,

Or Y notifies its E affiliates that C has N Zs and the E affiliates auction or bid for those Zs with X. The result that X sells C's points to the highest bidder.

In any event Y converts points to Z's (which may be points or a currency known or invented), and E purchases Z's off Y to establish an account for C.

Or in the alternate, Y converts points to Z's (which may be points or a currency known or invented), and Y pays E an amount for E to take over the Z liability.

The method of the invention also provides that C can convert or exchange some or all of their loyalty points with X to a common, actual or invented means of exchange or currency “Z”. Y converts the customer's points to Z. In preferred embodiments Z is then used with Y, to allow the customer or his agent or assignee or nominee to engage in a transaction.

Y sets the rates of conversion to Z either alone or in affiliation with its partners X and or E. Z may be a known currency (such as US dollars) or a virtual or invented currency.

By way of a simple example:

C holds 100,000 points with X and X has determined that 1 point presents a 1 penny liability (e.g. $1000).

E is offering a 2 penny promotional Z per point at its Las Vegas Casino that can be used for 75% of a room payment or in promotional gaming dollars.

C is visiting Las Vegas and decides to take E's offer and stay with E.

Y offers to take C's points from X at a cost to X of 0.5 penny per point. X buys and hence X has reduced its liability for C's points by 100% in that transaction at a cost of 50% of what it would have cost if C had opted to use the points in a transaction with X.

Y then offers to pay E, 0.2 penny per point and E1 takes the offer.

Y makes 100,000*(0.5-0.2)=$300 on that transaction.

Y then provides C with $2000 in promotional Z's for E1 and C uses those Z's to purchase 75% of five nights of accommodation and balance as promotional gaming dollars.

E has earned $200 from the transaction+25% of five night's accommodation (say $1000) and secured C as a customer on property with $1000 in promotional play to put through the machines.

C also has perceived real money value in excess of the value of C's points equivalent had they used those points with X.

Another embodiment may involve cash or points. In this example, Y acts as a broker for C and negotiates with the various E's to obtain an attractive deal for E. For example, C notifies Y of an intention to visit Las Vegas. C may post a basic profile with Y along with a commitment to spend either points or real money, and Y then gets the various E's to bid for C's points or cash in terms of promotional play or other benefits. In this example C puts up US$1000. Y takes 10% commission and offers US$900 for bids to the E's participating. The highest bid is $1500 in promotional play at Casino E1. C takes the offer and as a result may also decide to stay with that particular casino. Y may well be a travel site or travel broker or agent or Y may have a deal with such an entity or entities.

Y may also offer a lottery in partnership with Es and or Xs or on its own, where C may purchase tickets for Zs. At a determined frequency (e.g. once a week) the total of Z wagered in that period is pooled. A fractional sum (e.g. 50%) goes towards the prize and a second fraction or fee is retained by Y for provision of service (perhaps 20%) goes towards the operator, Y.

Y and the player cash out by either converting Z to actual cash, stock (and then cashing the stock), further entitlements, or merchandise.

In the event there are multiple companies involved (e.g. X1, X2, X3), then the liability for the prize must be paid out in proportion to the contribution of points to the pool. For example, if 60,000 of the 100,000 points wagered was contributed by X1 and 40,000 by X2 and the prize is 50%, then X1 would pay 30,000 points and X2 20,000 points.

FIG. 6 illustrates is a flow chart depicting a lottery involving loyalty points.

By way of a simple example:

Y presents an offer to all of X's customers to convert their points to Zs where 100 Zs buys a lottery ticket with a prize that increases subject to participation, with a minimum advertised guaranteed amount.

A total number of C's participate representing 100,000,000 point liability where one point=1 penny. Total=$1,000,000.

X pays Y 0.4 c per point=$400,000.

Y then pools the bets and determines to pay a prize of $250,000.

C wins the prize and so Y pays.

Y has made $150,000 in the transaction.

X has effectively made $600,000 in the transaction through a reduction in liability.

What is claimed is:

1. A method for an operator of a gambling game or game of chance to administer it, comprising the steps of:
admitting a player into a licensed area;
enabling a player to participate in a game in which an outcome is determined before, during or immediately after participation;
storing a result of the participation onto a database;
enabling the player to re-play the participation or the results of it by accessing the contents of the database later in time when the player is remote to the area.

2. The method of claim 1, wherein:
the operator allows the player to redeem any winnings in the area but after the re-play.

3. The method of claim 1, further comprising the step of:
the operator enabling the download of results of participation to a mobile device operated by the player so as to display the results remotely.

4. A method for an operator of a networked game to administer it, comprising the steps of:
offering to players, a networked game of skill, chance or stamina;
enabling players to purchase or obtain a game based currency for use in the game, the game based currency being represented by any one of the following: a representation of real money, simulated money, an invented currency or loyalty points;
enabling players or spectators to wager on an outcome of the game; and
enabling players or spectators to insure themselves or insure against a particular outcome or purchase, at a cost, an enhancement that is used during the game to increase the likelihood of success;
obtaining a payment from the sale of the insurance, wager or enhancement.

5. The method of claim 4, further comprising the step of:
enabling a player or participant to engage in a financial transaction with a virtual gaming house within the game.

6. A method for an operator of a gambling game or game of chance to administer it, comprising the steps of:
providing a server for a player to interact with a networked game;
enabling a player to purchase a game in which an outcome is determined;
storing a result of the game onto a database;
enabling the player to witness the result of the game by accessing the contents of the database at any time later than when the result is determined.

7. The method of claim 6, wherein:
the operator allows the player to redeem any winnings at a licensed area.

8. The method of claim 6, wherein:
the said enabled witnessing of the result is a first time that the player observes the result.

9. The method of claim 6, wherein:
the operator allows the player to view the result using a number of different graphical or sensory representations of the same result 10. The method of claim 6, wherein:
the game is a multi-state game and a reward for a win is independent of a choice made by a player during an instance of play, a bonus being used to compensate for a displayed result that is inferior with respect to a potentially superior result that the player could have obtained within the same instance of play.

11. A method for a provider of services to promote gaming business operators for a fee, comprising the steps of:
obtaining from a potential customer, preferences regarding a planned visit;
distributing the preferences to a number of potential operators that have the potential to service the customer's preferences;
obtaining bids by one or more of the operators;
the bid comprising an offer based on any one of: price, discounts, promotional game play, cash entertainment or meals;
enabling the customer to select an operator based on the operators bid;
the provider obtaining a fee from the operator in exchange for the customer's selection.

12. A method for administering a web based agency for brokering loyalty points, comprising the steps of:
obtaining a variety of different types of existing loyalty points from users;
performing a conversion of each type of point to a single pseudo currency that is accepted by organisations that trade in goods or services or gaming or lottery or gambling;
returning pseudo currency to the users;
obtaining a fee for the conversion.

13. The method of claim 4, further comprising the step of:
enabling a player to be depicted on a play screen as a representation or avatar.

14. The method of claim 6, wherein:
the game is a multi-state game and a reward for a win is independent of a choice made by a player during an instance of play, the player being enabled to replay the game until such time as a later result is equal to the superior result.

15. A point based lottery.
